(19) United States
(12) Patent Application Publication
(10) Pub. No.: US 2008/0278776 A1
(43) Pub. Date: Nov. 13, 2008

(54) Scanning module and scanner using the same

(75) Inventors: Thomas Sheng, Hsinchu (TW); Devon Shyu, Tainan County (TW); Jen-Chien Chang, Yilan County (TW)

Correspondence Address: BACON & THOMAS, PLLC, 625 SLATERS LANE, FOURTH FLOOR, ALEXANDRIA, VA, 22314-1176, US

(73) Assignee: AVISION INC., Hsinchu (TW)

(21) Appl. No.: 12/078,907

(22) Filed: Apr. 8, 2008

(30) Foreign Application Priority Data
May 10, 2007 (TW) 96116703

(51) Int. Cl. H04N 1/04

(52) U.S. Cl. 358/498; 358/497

(57) ABSTRACT

A scanning module disposed on one side of a transparent platen of a scanner for scanning a document disposed on the reverse side of the transparent platen is provided. The scanning module comprises a base, a lamp, a holder and an optical sensing component. The lamp for illuminating the document comprises a first section and a second section. The first section extends substantially parallel to a plane of the transparent platen. A first end of the second section is connected to one end of the first section. The shortest distance between a second end of the second section and the transparent platen is greater than that between the first section and the transparent platen. The holder is disposed on the second section for fixing the lamp to the base. The optical sensing component is used for receiving the light reflected by the document and converting that into an image signal.

This application claims the benefit of Republic of Taiwan application Serial No. 96116703, filed May 10, 2007, the subject matter of which is incorporated herein by reference.

### BACKGROUND OF THE INVENTION

1. Field of the Invention

The invention relates in general to a scanning module and scanner using the same, and more particularly to a scanning module with which the luminance of the light source for scanning a document is increased and a scanner using the scanning module.

2. Description of the Related Art

Most of the flatbed scanners and the scanners having automatic document feeders (ADF) still adopt cold cathode fluorescence lamps (CCFL) as the scanning light source. The CCFL having the advantages of low power consumption, high luminance, long lifespan and versatile shapes has been widely used as active light source in optical devices.

Due to the design of light emitting mechanism, the two ends of CCFL have weaker luminance than the middle section. In order to resolve the problem, the lamp is usually lengthened and only the middle section is used as a light source. However, in order to accommodate the lengthened lamp, the overall width of the scanning device needs to be increased. Furthermore, as the CCFL needs to be disposed close to the transparent platen so as to maximize the efficiency of the light source illuminating, the heat however generated by the electrodes disposed at the two ends of the lamp would heat up the transparent platen, and possibly burn the user.

### SUMMARY OF THE INVENTION

The invention provides a scanning module and a scanner using the same. According to the invention, the luminance of the light source is efficiently applied, while the dimensions of the scanner remain unchanged, and thus the lamp heating problem can be eliminated.

According to a first aspect of the present invention, a scanning module is disposed on one side of a transparent platen of a scanner is provided. The scanning module is used for scanning a document disposed on the reverse side of the transparent platen. The scanning module comprises a base, a lamp, a holder and an optical sensing component. The lamp used for illuminating the document comprises a first section and a second section. The first section extends substantially parallel to a plane of the transparent platen. A first end of the second section is connected to one end of the first section. The shortest distance between a second end of the second section and the transparent platen is greater than that between the first section and the transparent platen. The holder is disposed on the second section for fixing the lamp to the base. The optical sensing component is used for receiving the light reflected by the document and converting that into an image signal.

According to a second aspect of the present invention, a scanner including a housing and a scanning module is provided. The housing has a transparent platen. The scanning module is disposed on one side of the transparent platen for scanning a document disposed on the reverse side of the transparent platen. The scanning module includes a base, a lamp, a holder and an optical sensing component. The lamp used for illuminating the document includes a first section and a second section. The first section extends substantially parallel to the plane of the transparent platen. A first end of the second section is connected to one end of the first section. The shortest distance between a second end of the second section and the transparent platen is greater than that between the first section and the transparent platen. The holder is disposed on the second section for fixing the lamp to the base. The optical sensing component is used for receiving the light reflected by the document and converting that into an image signal.

The invention will become apparent from the following detailed description of the preferred but non-limiting embodiments. The following description is made with reference to the accompanying drawings.

### BRIEF DESCRIPTION OF THE DRAWINGS

FIG. 1 is a diagram showing a perspective view of a scanner according to a preferred embodiment of the invention; and

FIG. 2 is a diagram showing a cross-sectional view of a scanning module and a transparent platen disposed inside the scanner of FIG. 1.

### DETAILED DESCRIPTION OF THE INVENTION

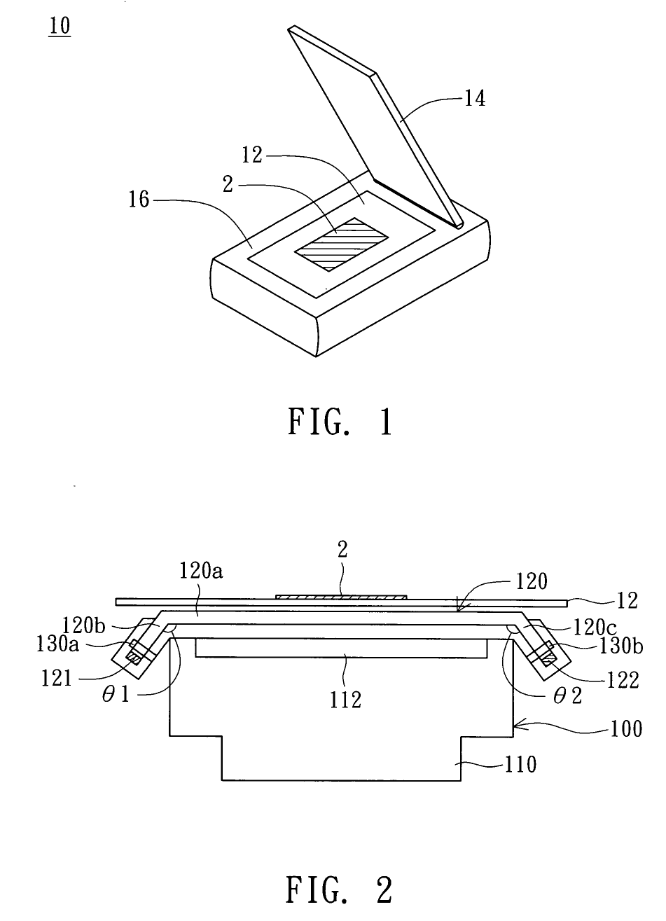

Referring to FIG. 1, a diagram of a perspective view of a scanner according to a preferred embodiment of the invention is shown. The scanner 10 includes a housing 16 and an upper cover 14 disposed on the housing 16. The housing 16 has a transparent platen 12. A document 2 is placed on one side of the transparent platen 12. In the present embodiment of the invention, the document 2 is placed on the transparent platen 12. The transparent platen 12 is a glass plate or a heat-resistance reinforced plastic plate.

Referring to FIG. 2, a diagram of a cross-sectional view of a scanning module and a transparent platen disposed inside the scanner of FIG. 1 is shown. The scanning module 100 for scanning the document 2 is disposed on the reverse side of the transparent platen 12. In the present embodiment of the invention, the scanning module 100 is disposed underneath the transparent platen 12. The scanning module 100 includes a base 110, a lamp 120, and a holder 130a. The lamp 120 is used for illuminating the document 2. The lamp 120 includes a first section 120a and a second section 120b, wherein the first section 120a extends substantially parallel to the plane of the transparent platen 12. As the holder 130a for fixing the lamp 120 is disposed on the second section 120b, and the first section 120a is no longer hindered by the holder 130a. Thus, the first section 120a as the main illuminating portion can be disposed closer to the transparent platen 12. As the illuminance on the document 2 is inversely proportional to the square of the distance between the lamp 120 and the transparent platen 12, the illuminance on the document 2 is thus increased. The optical sensing component 112 is disposed on the base 110 for receiving the light reflected by the document 2 and converting that into an image signal. As the illuminance on the document 2 is increased, the intensity of the light signal received by the optical sensing component 112, such as a charge-coupled device (CCD) or a contact type image sensor (CIS), also increases. As a result, the image is less likely to be distorted. Besides, as the illuminance on the document 2 is increased, the required exposure time is shortened so that the scanning speed is increased. Despite the lamp 120 of the present embodiment of the invention is exemplified by a cold cathode fluorescence lamp (CCFL), in actual application, the lamp 120 can be embodied by other illuminating means such as light emitting diode (LED) in combination with light-guiding rod or the like.

In the present embodiment of the invention, the first section 120a and the second section 120b are bent to form a contained angle θ1. The contained angle θ1 may be an acute angle, a right or an obtuse angle. The present embodiment of the invention is exemplified by obtuse angle. In the present embodiment of the invention, one end of the second section 120b is connected to one end of the first section 120a, the other end of the second section 120b has an electrode 121, and the shortest distance between the electrode 121 and the transparent platen 12 is greater than that between the first section 120a and the transparent platen 12. That is, as a result of the design of a bent lamp 120, the electrode 121 of the lamp 120 is kept farther away from the transparent platen 12, lest the electrode 121 might heat the transparent platen 12 and result in burning the user.

The holder 130a is disposed on the second section 120b for fixing the lamp 120 to the base 110. Preferably, the holder 130a neighbors the electrode 121. The lamp 120 of the present embodiment of the invention further includes a third section 120c, wherein one end of the third section 120c is connected to the other end of the first section 120a to form a second contained angle θ2. The other end of the third section 120c has a second electrode 122, and the distance between the second electrode 122 and the transparent platen 12 is greater than the distance between the first section 120a and the transparent platen 12. Likewise, the second holder 130b is disposed on the third section 120c for fixing the lamp 120 to the base 110, and preferably, the second holder 130b also neighbors the second electrode 122. That is, the lamp 120 is bent at two ends, so that both of the electrode 121 and the second electrode 122 are kept away from the transparent platen 12. Moreover, the holder 130a and the second holder 130b respectively neighbor the electrode 121 and the second electrode 122 for fixing the second section 120b and the third section 120c.

In the present embodiment of the invention, the scanner 10 is exemplified by a flatbed scanner and the scanning module 100 incorporated with the scanner 10 is exemplified by a movable scanning chassis. In practical application, the invention can also be used in a scanner having automatic document feeder (ADF) or a book scanner, and incorporated with a stationary scanning module. In the present embodiment of the invention, both ends of the lamp have a bending section. However, as long as the design that at least one end of the lamp has a bending section and a holder is used for fixing the bending section, the design is within the scope of protection of the invention.

According to the scanning module and the scanner using the same disclosed in the above embodiment of the invention, the lamp is bent and the holder is used for fixing the bending section, so that the main illuminating portion of the lamp could be disposed at a position closer to the transparent platen. As a result, the illuminance of the scanning light source on the document is increased, hence improving image quality and shortening the required exposure time. Also, the electrode disposed at one end of the lamp is kept away from the transparent platen lest the electrode might heat the transparent platen.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A scanning module, disposed on one side of a transparent platen of a scanner, for scanning a document disposed on the reverse side of the transparent platen, the scanning module comprising:
a base;
a lamp used for illuminating the document, comprising a first section and a second section, the first section extends substantially parallel to a plane of the transparent platen, a first end of the second section is connected to one end of the first section, wherein the shortest distance between a second end of the second section and the transparent platen is greater than the shortest distance between the first section and the transparent platen;
a holder, disposed on the second section, for fixing the lamp to the base; and
an optical sensing component, disposed on the base, for receiving the light reflected by the document and converting the light into an image signal.

2. The scanning module according to claim 1, wherein the second end of the second section has an electrode.

3. The scanning module according to claim 2, wherein the holder neighbors the electrode.

4. The scanning module according to claim 1, wherein the lamp further comprises:
a third section, wherein a first end of the third section is connected to the first section, and the shortest distance between a second end of the third section and the transparent platen is greater than the shortest distance between the first section and the transparent platen; and
a second holder, disposed on the third section, for fixing the lamp to the base.

5. The scanning module according to claim 4, wherein the second end of the third section has a second electrode.

6. The scanning module according to claim 5, wherein the second holder neighbors the second electrode.

7. The scanning module according to claim 1, wherein the lamp is a cold cathode fluorescence lamp (CCFL).

8. The scanning module according to claim 1 is a movable scanning module.

9. The scanning module according to claim 1 is a stationary scanning module.

10. A scanner, comprising:
a housing having a transparent platen; and
a scanning module, disposed on one side of the transparent platen, wherein the scanning module is used for scanning a document disposed on the reverse side of the transparent platen, the scanning module comprises:
a base;
a lamp, for illuminating the document, comprising a first section and a second section, the first section extends substantially parallel to a plane of the transparent platen, a first end of the second section is connected to one end of the first section, wherein the shortest distance between a second end of the second section and the transparent platen is greater than the shortest distance between the first section and the transparent platen;
a holder, disposed on the second section, for fixing the lamp to the base; and
an optical sensing component, disposed on the base, for receiving the light reflected by the document and converting the reflected light into an image signal.

11. The scanner according to claim 10, wherein the second end of the second section has an electrode.

12. The scanner according to claim 11, wherein the holder neighbors the electrode.

13. The scanner according to claim 10, wherein the lamp further comprises a third section, a first end of the third section is connected to the first section, and the shortest distance between a second end of the third section and the transparent platen is greater than the shortest distance between the first section and the transparent platen; and
a second holder, disposed on the third section, for fixing the lamp to the base.

14. The scanner according to claim 13, wherein the second end of the third section has a second electrode.

15. The scanner according to claim 14, wherein the second holder neighbors the second electrode.

16. The scanner according to claim 10, wherein the lamp is a cold cathode fluorescence lamp.

17. The scanner according to claim 10 being a flatbed scanner.

18. The scanner according to claim 10 further comprising an automatic document feeder (ADF).
